(19) United States
(12) Patent Application Publication
(10) Pub. No.: US 2008/0101595 A1
(43) Pub. Date: May 1, 2008

(54) Error correction system and method for mobile terminal

(75) Inventor: Jong Phil Lee, Daegu Metropolitan City (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/902,000

(22) Filed: Sep. 20, 2007

(30) Foreign Application Priority Data
Oct. 26, 2006 (KR) 2006-0104673

(51) Int. Cl. H04L 9/28

(52) U.S. Cl. 380/28

(57) ABSTRACT

An error correction system and method for a mobile terminal is provided that are capable of correcting transmission packet errors. The error correction method for a mobile communication system including at least one mobile terminal receiving ciphered text from a network includes generating an output by applying an input parameter containing an overflow counter calculated by the mobile terminal to a predetermined algorithm; deciphering the ciphered text using the output to recover a clear text; updating the overflow counter if the ciphered text is not successfully deciphered; regenerating the output using the updated overflow counter; and recovering the clear text using the regenerated output with the ciphered text.

### CLAIMS OF PRIORITY

This application claims priority to an application entitled “ERROR CORRECTION SYSTEM AND METHOD FOR MOBILE TERMINAL,” filed in the Korean Intellectual Property Office on Oct. 26, 2006 and assigned Serial No. 2006-0104673, the contents of which are incorporated herein by reference.

### BACKGROUND OF THE INVENTION

1. Field of the Invention

The present invention relates to a mobile terminal and, in particular, to an error correction system and method for a mobile terminal that are capable of correcting transmission packet errors.

2. Description of the Related Art

A mobile communication system enables mobile terminals to communicate with each other through an air interface. In order to enhance the quality of service (QoS) on the unstable wireless channels, research and development have been made in to improve the quality of service for various wireless communication systems. For example, such systems include General Packet Radio service (GPRS), Enhanced GPRS (EGPRS), and Global System for Mobile communication (GSM), and Enhanced Data rate for Global Evolution (EDGE) Radio Access Network (GERAN).

A ciphering/deciphering process is essential for GPRS communication, while GSM selectively uses ciphering/deciphering. Such ciphering/deciphering is used in a terminal authentication process. Ciphered data are contained in Logical Link Control (LLC) packet data and are transmitted to a counterpart terminal through a GPRS network. However, the LLC packet data may be lost while traveling between the mobile terminal and the GPRS network, especially in a poor channel environment. Such an LLC packet loss causes incomplete information for a ciphering/deciphering process, resulting in packet decoding error.

### SUMMARY OF THE INVENTION

The present invention has been made in an effort to reduce or overcome the above problems in the art and provides additional advantages, by providing a transmission error correction system and method for a mobile phone that are capable of correcting transmission packet error.

In accordance with an aspect of the present invention, an error correction method for a mobile communication system includes at least one mobile terminal receiving a ciphered text from a network. The error correction method includes generating an output using an input parameter containing an overflow counter calculated by the mobile terminal to a predetermined algorithm; deciphering the ciphered text using the output with the ciphered text to recover a clear text; updating the overflow counter if deciphering the ciphered text fails; regenerating the output using the updated overflow counter; and recovering the clear text using the regenerated output with the ciphered text.

In accordance with another aspect of the present invention, an error correction system for a mobile terminal in which the mobile terminal receives a ciphered text from a network includes a logical link control layer to transmit logical link control data having a ciphered text; a radio frequency unit to perform modulation and demodulation on the ciphered text; and a controller to decipher the ciphered text using the output with the ciphered text to recover a clear text, updating the overflow counter if deciphering the ciphered text fails, regenerating the output using the updated overflow counter, and recovering the clear text using the regenerated output with the ciphered text.

### BRIEF DESCRIPTION OF THE DRAWINGS

The present invention will be more apparent from the following detailed description in conjunction with the accompanying drawings, in which:

FIG. 1 is a schematic block diagram illustrating a mobile communication system employing an error correction system and method according to an embodiment of the present invention;

FIG. 2 is a block diagram illustrating a ciphering/deciphering process of an error correction system according to an embodiment of the present invention;

FIG. 3 is a block diagram illustrating a configuration of the error correction system according to an embodiment of the present invention;

FIG. 4 is a conceptual view illustrating a GPRS transmission plane for the error correction system of FIG. 3; and

FIG. 5 is a flowchart illustrating an error correction method for a mobile terminal according to an embodiment of the present invention.

### DETAILED DESCRIPTION OF THE PRESENT INVENTION

Now, embodiments of the present invention are described with reference to the accompanying drawings in detail. The same reference numbers are used throughout the drawings to refer to the same or like parts. For the purposes of clarity and simplicity, detailed descriptions of well-known functions and structures incorporated herein may be omitted to avoid obscuring the subject matter of the present invention.

Certain terms are used in the following description for convenience and reference only and are not limiting. In the following detailed description, only the exemplary embodiments of the invention have been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature and not restrictive.

The error correction system and method of the present invention are described in association with a mobile phone. However, the present invention is not limited to the mobile phone, but, can be adapted to portable devices such as a digital broadcasting receiver, Personal Digital Assistant (PDA), and Smartphone. The mobile phone also can be a 3^{rd} generation terminal, Code Division Multiple Access (CDMA) terminal, GSM terminal, and GPRS terminal.

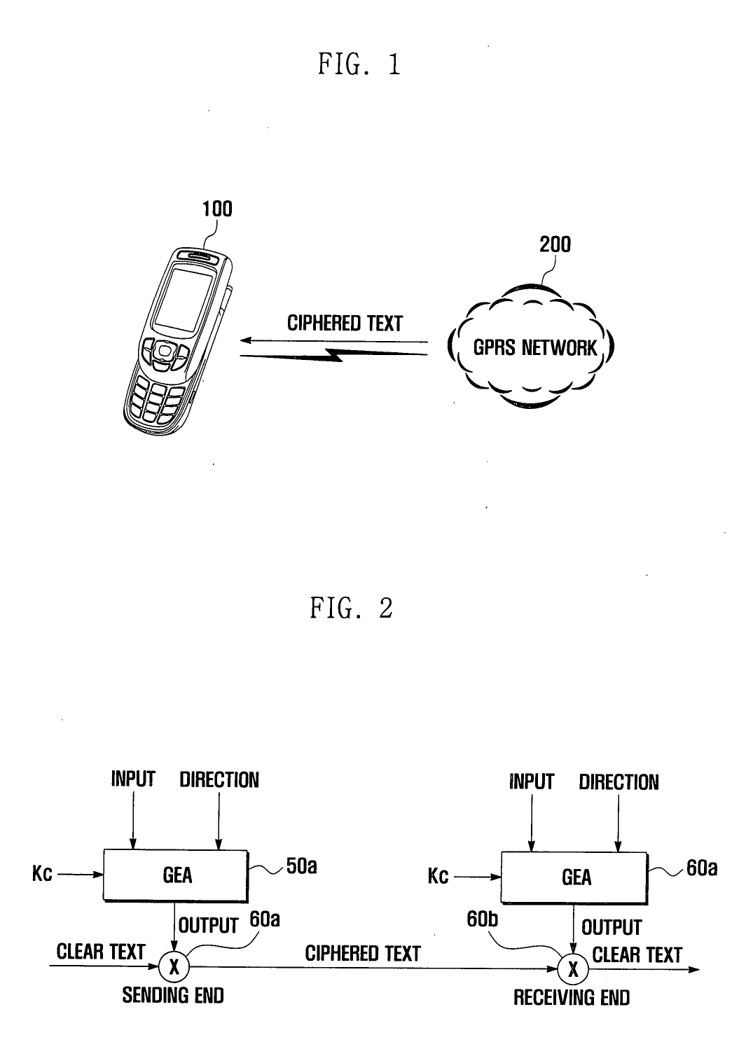

FIG. 1 is a schematic block diagram illustrating a mobile communication system employing an error correction system and method according to an embodiment of the present invention.

Referring to FIG. 1, the mobile communication system includes a mobile terminal 100 and a GPRS network 200 providing a packet transmission service to the mobile terminal 100.

When the mobile terminal 100 requests a packet transmission to the GPRS network 200, the GPRS network 200 transmits packets to the mobile terminal 100. In order to establish a wireless packet communication channel, the mobile terminal 100 and the GPRS network 200 exchanges the ciphering/deciphering information through LLC protocol data unit (PDU).

FIG. 2 is a block diagram illustrating a ciphering/deciphering process of an error correction system according to an embodiment of the present invention. In the present invention, each of the mobile terminal 100 and the GPRS network 200 can be a sending end or a receiving end.

Referring to FIG. 2, a sending end includes a first ciphering/deciphering module 50a and a first mixer 60a, and a receiving end includes a second ciphering/deciphering module 60a and a second mixer 60b.

The first ciphering/deciphering module 50a is implemented with a GPRS encryption algorithm (GEA) to which INPUT, DIRECTION and ciphering key Kc are input. An output of the first ciphering/deciphering module 50a is exclusive-OR'd with a clear text at the first mixer 60a so as to be outputted as a ciphered text. INPUT is a sequence number of an LLC packet and its initial value is selected by the GPRS network 200. INPUT is obtained by equation (1) when transmitting an Unacknowledged Information (UI) frame and by equation (2) when transmitting an Acknowledged Information (I) frame.

Input=(IOV_{—}UI\textcircled{×}SX+LFN+OC)modulo2³² (1)

Input=(IOV_{—}I+LFN+OC)modulo2³² (2)

where Input is a sequence number, IOV_UI is a 32-bit random value generated by a Serving GPRS Support Node (SGSN) in UI frame transmission mode, IOV_I is a 32-bit random value generated by the SGSN, LFN is a 9-bit frame number of LLC data, and OC is a 32-bit overflow counter calculated by the sending and receiving ends, and SX is a Service Access Point Identifier (SAPI) exclusive-OR mask. LFN increases by 512 and SX is 2²⁷\textcircled{×}SAPI+2³¹.

DIRECTION is either from the mobile terminal 100 to the GPRS network 200 or from the network 200 to the mobile terminal 100 allowing INPUT to be identical in both directions.

The ciphering key (Kc) is generated using an algorithm A8 with a secret subscriber authentication key and a random number generated by the GPRS network 200. The secret subscriber authentication key and A8 are stored in the mobile terminal 100 and the GPRS network 200, and the random number is transmitted to the mobile terminal 100.

The first mixer 60a mixes the output of the first ciphering/deciphering module 50a with the clear text so as to output a ciphered text to the receiving end. At this time, the ciphered text is generated by performing an exclusive OR operation with the output of the ciphering/deciphering module 50a with the clear text.

The second ciphering/deciphering module 50b uses the algorithm and INPUT value identical to those of the first ciphering/deciphering module 50a so as to output the same value to the second mixer 60b.

The second mixer 60b performs an exclusive-OR operation with the output of the second ciphering/deciphering module 50b and the ciphered text so as output the clear text.

The identical INPUT, DIRECTION, and Kc are input to the first and second ciphering/deciphering modules 50a and 50b. Also the OC and LFN values have identical values in the sending end and receiving end, respectively.

In the case that an LLC data loss occurs between the mobile terminal 100 and the GPRS network 200, the OCs of the sending end and the receiving end have different values.

For example, assuming that the mobile terminal 100 moves from one cell to another and 400 LLC packets are lost in a cell selection procedure and that the GPRS network 200 has an initial LFN=500 and OC=1024. Then, the LFN has a value of 388 after completing the cell selection, which is obtained by summing the previous LFN=500 and an LLC data value=400 and then performing modulo operation with 512. At this time, the OC increases by 512 from 1024 to 1536, according to the variation of the LFN value due to the LLC data loss.

Since the mobile terminal 100 has initial values of LFN=500 and OC=1024 and the LLC data is lost during the cell selection procedure, the mobile terminal maintains the LFN of 500 and OC of 1024, respectively. Accordingly, the GPRS network 200 and the mobile terminal 100 have different LFN and OC values, whereby the deciphering reliability is reduced.

In the present invention, the OC value is coercively changed by 512 so as to be synchronized with that of the GPRS network 200, resulting in improvement of deciphering reliability.

Even though the values of LFN differ from each other a little, the input value is not influenced by the LFN because LFN is 9 bits long and INPUT is calculated by modulo operation with 2³². However, the change of OC value makes an effect to the INPUT through the 2³² modulo operation since the OC is 32-bits long. Accordingly, only OC synchronization is required between the mobile terminal 100 and the GPRS network 200 for successful deciphering.

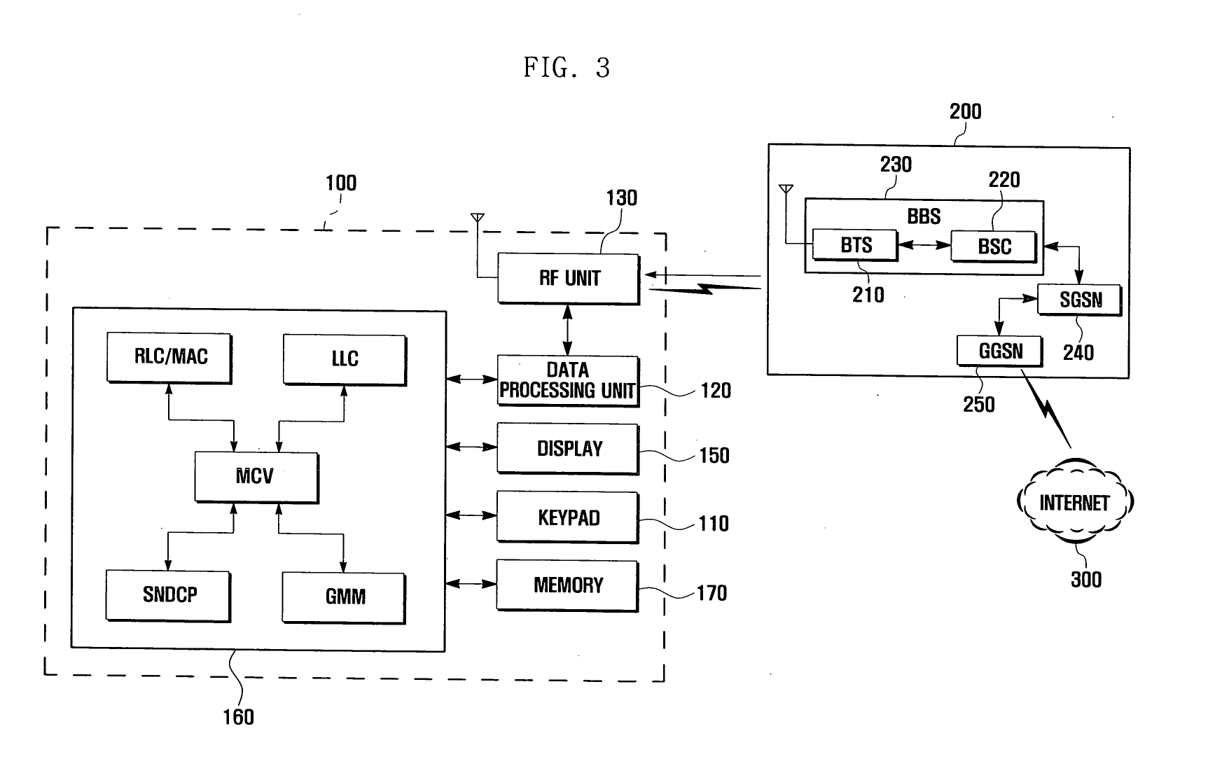

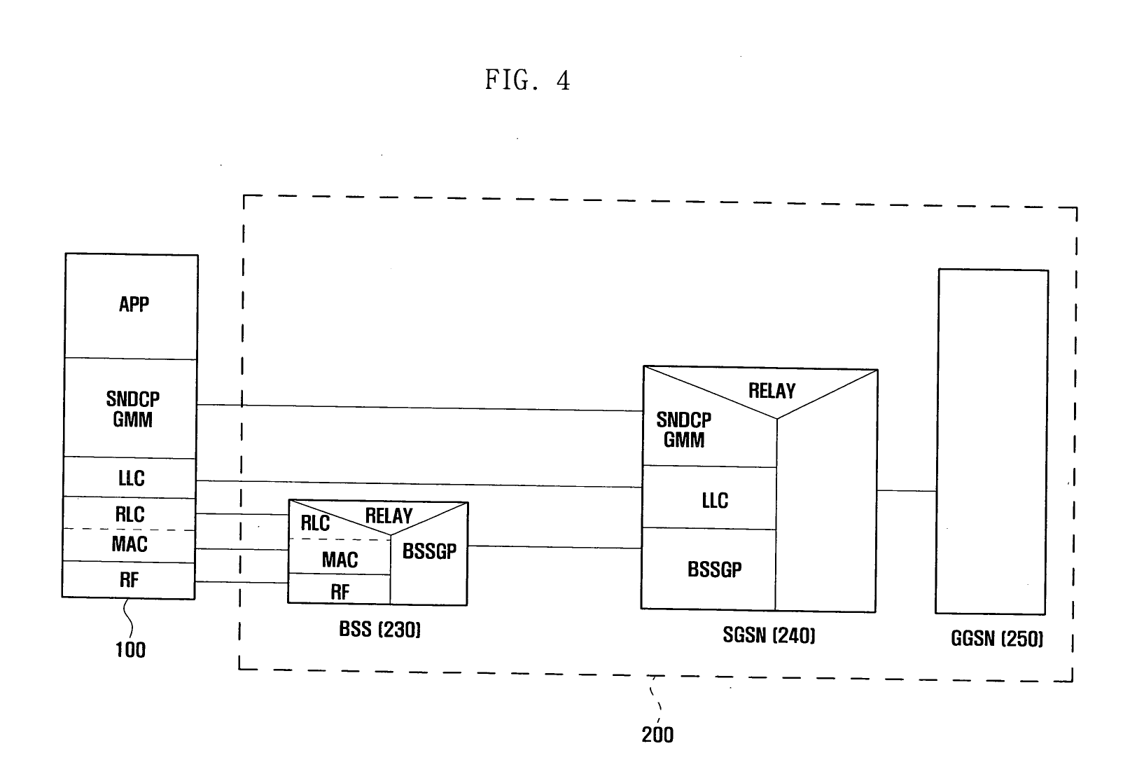

FIG. 3 is a block diagram illustrating a configuration of an error correction system according to an embodiment of the present invention. FIG. 4 is a conceptual view illustrating a GPRS transmission plane for the error correction system of FIG. 3.

Referring to FIGS. 3 and 4, the error correction system includes a mobile terminal 100, and a GPRS network 200 enabling the mobile terminal to access to the Internet 300.

The mobile terminal 100 includes a display 150, a keypad 110, a memory 170, a data processing unit 120, a radio frequency (RF) unit 130, and a microcontroller unit (MCU) 160 for processing data exchange with the GPRS network 200.

The memory 170 provides a Radio Link Control/Media Access Control (RLC/MAC) unit, a Subnetwork Dependent Convergence Protocol (SNDCP) unit, a GPRS Mobility Management (GMM) unit, programs enabling the MCU 160 to execute software routines, and Logical Link Control (LLC) unit.

The MCU 160 is electrically connected to the memory 170 which stores an operating system, received packet data, data to be transmitted, and user data.

When an error is detected while deciphering a ciphered text, the MCU 160 coercively changes the value of OC so as to repeat the deciphering process. The MCU 160 changes the value of OC in unit of 512 and applies the changed OC value to the deciphering process. For example, when the OC=1024, the MCU 160 decreases the OC value by 512 and performs the deciphering process with the OC=512. If the deciphering fails, the MCU 160 performs with an OC 1536 increased by 512.

The GPRS network 200 comprises a Base Sub-System (BSS) 230 including a Base Transceiver Station (BTS) 210 and a Base Station Controller (BSC) 220 having a Packet Control Unit (PCU), a Serving GPRS Support Node (SGSN), and a Gateway GPRS Support Node (GGSN) for interfacing the GPRS network 200 with external networks such as the Internet 300.

An application layer of the mobile terminal 100 is the highest layer, which is responsible for displaying and activating the ciphered text. The SNDCP unit and GMM unit are positioned on the same layer. The BSC 220 of the GPRS network 200 is provided with an RLC/MAC unit and a BSS GPRS Protocol (BSSGP) unit, and the SGSN 240 of the GPRS network 220 is provided with a BSSGP unit, LLC unit, SNDCP unit, and GMM unit. The SNDCP unit and GMM unit of SGSN 240 are positioned on the same layer.

A packet data message including the ciphered text is transmitted through a logical link established between LLC units above the RLC unit of the mobile terminal 100 and the BSSGP unit of the SGSN 240.

The ciphered text is carried by an LLC protocol data unit (LLC PDU).

Above the LLC unit, the SNDCP unit is positioned for exchanging the user data between the mobile terminal 100 and the SGSN 240. The LLC unit provides services to the GMM unit and SNDCP unit and the services are distinguished by Service Access Point Identifiers (SAPIs). The SAPI is carried in an address field of a header of the LLC PDU. The LLC PDUs are segmented and reassembled as RLC/MAC PDUs.

When the LLC PDUs are traveling between the mobile terminal 100 and the BSS 230 and between the BSS 230 and SGSN 240, a relay unit provides an RLC protocol service. The LLC PDUs are combined by Service Access Point (SAP). The LLC PDU contains user data or GPRS protocol-related messages such as a GMM signaling message (GMM/SM).

The SAPI is used to identify the SAP in the mobile terminal 100 and the SGSN 240, and is carried in an address field of the LLC frame header. SAPI is used to identify the upper layer entities processing the LLC PDU carrying the GMM, SMS, and SNDCP data.

The LLC unit is used to exchange data between the mobile terminal 100 and the SGSN 240, and is transparent to underlying radio interface protocols. The LLC unit includes Logical Link Management Entities (LLMEs) and Logical Link Entities (LLEs) and is responsible for multiplexing the LLMEs and LLEs. The LLE is an LLC unit protocol status machine to control a logical link establishment.

The LLC unit operates above the RLC unit at the mobile terminal 100 and above the BSSGP unit at the SGSN 240. Above the LLC unit, the SNDCP unit is located to control transmission of Network layer Protocol Data Units (N-PDUs). Also, the GMM unit is located on the LLC unit and uses the services of the LLC unit to exchange the ciphered text between the mobile terminal 100 and the SGSN 240.

The MAC unit operates right below the RLC unit. The MAC unit handles access to a shared medium such that a plurality of mobile terminals can access the GPRS network 200. The MAC unit is also responsible for arbitrating between the mobile terminals trying to access to wireless interface.

The RLC unit is responsible for segmentation and reassembly of the RLC/MAC PDUs and performs link adaptation.

The RLC/MAC unit is also responsible for transmitting the LLC PDUs through a wireless interface using Temporary Block Flow (TBF), which supports unidirectional transfer of LLC PDUs on packet data physical channels between the mobile terminal 100 and the GPRS network 200.

The LLC unit supports an acknowledged and unacknowledged data transfer mode and the RLC/MAC unit supports an RLC acknowledged mode and RLC unacknowledged mode. The LLC modes and RLC modes operate independently. In the LLC acknowledged mode, the RLC unit supports an in-order delivery. In the LLC unacknowledged mode, the RLC unit does not support the in-order delivery. The acknowledged mode RLC uses a retransmission mechanism for guaranteeing a failure free transmission and the unacknowledged mode RLC does not guarantee the failure free transmission.

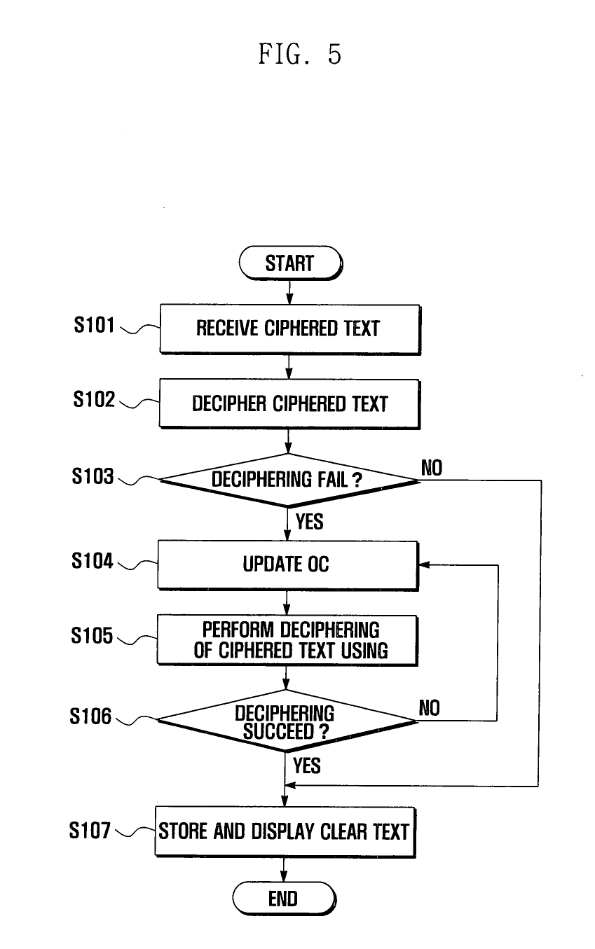

FIG. 5 is a flowchart illustrating an error correction method for a mobile terminal according to an embodiment of the present invention.

Referring to FIG. 5, in the error correction method when a ciphered text is received (S101), the mobile terminal 100 performs deciphering on the ciphered text (S102).

At step S101, the mobile terminal 100 and the SGSN 240 exchange control signals for establishing a communication channel. The SGSN 240 transmits packets in the form of a ciphered text to the mobile terminal 100 in response to a packet request. The ciphered text is generated by performing an exclusive-OR (XOR) operation with (1) an output generated by applying INPUT having an overflow counter (OC) independently calculated by the SGSN, (2) DIRECTION indicating a transmission direction of the ciphered text, (3) a ciphered key (Kc) generated by applying a security subscriber authentication key, (4) a random number to A8 algorithm to GEA algorithm, and (5) a clear text. INPUT at the SGSN 240 can includes IOV_UI or IOV_I and LFN value as parameters for reflecting the frame characteristic.

At step S102, the mobile terminal 100 deciphers the received ciphered text. In more detail, the mobile terminal 100 generates an output by applying three parameters: (1) INPUT having an overflow counter independently calculated by the mobile terminal 100, (2) DIRECTION, and (3) Kc, to the GEA. Then, it recovers a clear text by performing exclusive-OR (XOR) with the output and the received ciphered text. INPUT includes an LLC Frame Number (LFN), Overflow Counter (OC), and IOV_U or IOV_I reflecting the characteristic of the frame. DIRECTION is a parameter indicating a transmission direction of the ciphered text, either from the mobile terminal 100 to the GPRS network 200 or from the GPRS network 200 to the mobile terminal 100. The Kc is generated using identical parameters and algorithm to those users for generating Kc at the SGSN 240.

After performing the deciphering process, the MCU 160 determines whether the deciphering of the ciphered text fails (S103). If the deciphering fails, the MCU 160 increases or decreases the value of OC by a predetermined amount (S104).

At step S104, the MCU 160 increases or decreases the OC value of INPUT by a predetermined amount, for example 512. The value 512 is defined in the GSM specification, and can be changed if the GSM specification changes.

Next, the MCU 160 repeats the deciphering process on the ciphered text using the updated OC value (S105) and determines whether the deciphering succeeds (S106). If the deciphering fails, the MCU 160 returns to step S104.

The MCU 160 repeats the deciphering process after updating the OC value, and changes the OC value if the deciphering of the ciphered text fails. For example, if an initial OC value is 1024, the OC value can be set to 512 or 1536 after a first deciphering failure and set to 0 or 2048 after a second deciphering failure.

At step S106, if the deciphering succeeds, the MCU 160 stores the deciphered clear text within the memory 170 or displays the clear text on a screen of the display 150 (S107). The deciphering process is repeated with the OC value updated by deciphering failure.

The deciphered clear text is stored in the memory 170 temporarily or semi-permanently and also can be displayed on the display 150 in real time.

Although exemplary embodiments of the present invention are described in detail hereinabove, it should be clearly understood that many variations and/or modifications of the basic inventive concepts herein taught which may appear to those skilled in the present art will still fall within the spirit and scope of the present invention, as defined in the appended claims.

As described above, an error correction system and method of the present invention are advantageous in that a transmission error occurring between the mobile terminal and a system is corrected in a deciphering process without a retransmission procedure, thereby eliminating redundant network traffic.

What is claimed is:

1. An error correction method for a mobile communication system including at least one mobile terminal receiving a ciphered text from a network, the method comprising the steps of:
generating an output using an input parameter containing an overflow counter calculated by the mobile terminal and a predetermined algorithm;
deciphering the ciphered text using the output to recover a clear text;
updating the overflow counter if the ciphered text is not successfully deciphered;
regenerating the output using the updated overflow counter; and
recovering the clear text using the regenerated output with the ciphered text.

2. The error correction method of claim 1, wherein updating the overflow counter comprises incrementing or decrementing the overflow counter by a predetermined value.

3. The error correction method of claim 1, wherein the ciphered text is generated by performing an exclusive-OR (XOR) operation with an output generated by applying the input parameter having the overflow counter independently calculated by the network, a direction parameter indicating a transmission direction of the ciphered text, and a ciphered key parameter generated by applying a security subscriber authentication key and a random number to a predetermined algorithm, and the clear text.

4. The error correction method of claim 3, wherein recovering a clear text is performed by applying the direction parameter and the ciphered key parameter.

5. The error correction method of claim 1, wherein the overflow counter is set to different values at the mobile terminal and the network in accordance with logical link data loss of the mobile terminal.

6. The error correction method of claim 1, wherein the ciphered text is deciphered by performing an exclusive-OR operation with the output.

7. An error correction system for a mobile terminal in which the mobile terminal receives a ciphered text from a network, comprising;
a logical link control layer to transmit logical link control data having a ciphered text;
a radio frequency unit to perform modulation and demodulation on the ciphered text; and
a controller to decipher the ciphered text using the output to recovering a clear text, updating the overflow counter if the ciphered text is not successfully deciphered, regenerating the output using the updated overflow counter, and recovering the clear text using the regenerated output with the ciphered text.

8. The error correction system of claim 7, wherein the overflow counter increments or decrements by a predetermined value.

9. The error correction system of claim 7, wherein the ciphered text is generated by performing an exclusive-OR (XOR) operation with an output generated by applying the input parameter having the overflow counter independently calculated by the network, a direction parameter indicating a transmission direction of the ciphered text, and a ciphered key parameter generated by applying a security subscriber authentication key and a random number to a predetermined algorithm, and the clear text.

10. The error correction system of claim 9, wherein a clear text is recovered by applying the direction parameter and the ciphered key parameter used at the network.

11. The error correction system of claim 7, wherein the overflow counter is updated in accordance with a frame number of logical link data.

12. The error correction system of claim 7, wherein the wherein the ciphered text is deciphered by performing an exclusive-OR operation with the output.

13. The error correction system of claim 7, further comprising:
a memory for storing the clear text temporarily or semi-permanently; and
a display for displaying the clear text.
